(19) United States
(12) Patent Application Publication
(10) Pub. No.: US 2006/0184588 A1
(43) Pub. Date: Aug. 17, 2006

(54) Information processing apparatus, method, and program for executing retrieval processing

(75) Inventor: Masashi Takizawa, Yokohama-shi (JP)

Correspondence Address: Canon U.S.A. Inc.,;Intellectual Property Division, 15975 Alton Parkway, Irvine, CA, 92618-3731, US

(73) Assignee: Canon Kabushiki Kaisha, Ohta-ku (JP)

(21) Appl. No.: 11/347,449

(22) Filed: Feb. 3, 2006

(30) Foreign Application Priority Data
Feb. 15, 2005 (JP) 2005-037749

(51) Int. Cl. G06F 17/30

(52) U.S. Cl. 707/201

(57) ABSTRACT

An information processing apparatus that is connected to a network includes a live status confirmation message output unit configured to output a live status confirmation message to a plurality of information processing apparatuses via the network, a management unit configured to manage attribute information about an information processing apparatus that has responded to the live status confirmation message output by the live status confirmation message output unit, a determination unit configured to determine an information processing apparatus to which an information retrieval request is transmitted based on the attribute information about the information processing apparatus managed by the management unit, and a retrieval processing unit configured to transmit the information retrieval request to the information processing apparatus determined by the determination unit and to receive a retrieval result from the information processing apparatus determined by the determination unit.

### BACKGROUND OF THE INVENTION

1. Field of the Invention

The present invention relates to an information processing system for retrieving information stored in a plurality of apparatuses that are mutually connected via a network.

2. Description of the Related Art

In recent years, with the development of computers and networks, electronic information is accumulated in information processing apparatuses that include a storage device that stores a database and are distributed over a network. In this situation, a demand for development of information retrieval technology has been increasing.

Conventionally, there is an information retrieval technology for transmitting a retrieval request to all information processing apparatuses on a network. In addition, in a case where all of the information processing apparatuses on the network are recognized, the retrieval request is transmitted only to information processing apparatuses that are capable of retrieving information.

In addition, information indicating a processing capacity of the information processing apparatus is managed. For example, Japanese Patent Application Laid-Open No. 10-301864 discusses a technology for managing attribute information of a terminal apparatus indicating the processing capacity of each terminal apparatus under a network environment in which various kinds of information processing apparatuses exist. With this technology, an applied service can be provided in accordance with the processing capacity of each of the information processing apparatuses.

However, in the above conventional technology, in retrieving information with respect to electronic information in the information processing apparatuses distributed over the network, the retrieval request is transmitted to all of the information processing apparatuses, and accordingly, the traffic of the network increases. Especially when the retrieval request is issued and transmitted in relation to large size data such as image information, a flow in the network becomes substantially slow.

In addition, there are some information processing apparatuses among the information processing apparatuses on the network that cannot respond to the retrieval request. In such cases, an unnecessary retrieval request is transmitted.

Besides, in the conventional technology, the capability of responding to the retrieval request of the information processing apparatuses on the network is not managed in accordance with a connection/disconnection status of the information processing apparatuses.

### SUMMARY OF THE INVENTION

The present invention is directed to reducing the traffic of a network and reducing transmitting unnecessary retrieval requests to information processing apparatuses that are not provided with an information retrieving function.

In one aspect of the present invention, an information processing apparatus that is connected to a network includes a live status confirmation message output unit configured to output a live status confirmation message to a plurality of information processing apparatuses on the network, a management unit configured to manage attribute information of an information processing apparatus that has responded to the live status confirmation message output by the live status confirmation message output unit, a determination unit configured to determine an information processing apparatus to which to transmit an information retrieval request based on the attribute information of the information processing apparatus managed by the management unit, and a retrieval processing unit configured to transmit the information retrieval request to the information processing apparatus determined by the determination unit and to receive a retrieval result from the information processing apparatus determined by the determination unit.

In another aspect of the present invention, a retrieval processing method for an information processing apparatus connected to a network includes a live status confirmation message outputting step of outputting a live status confirmation message to a plurality of information processing apparatuses on the network, a determination step of determining an information processing apparatus to which to transmit an information retrieval request based on attribute information of an information processing apparatus that has responded to the live status confirmation message output in the live status confirmation message outputting step, an information retrieval request transmission step of transmitting the information retrieval request to the information processing apparatus determined in the determination step; and an information retrieval result receiving step of receiving a retrieval result from the information processing apparatus determined in the determination step.

In another aspect of the present invention, a computer-readable medium includes a program that executes a retrieval processing method for an information processing apparatus connected to a network. The retrieval processing method includes a live status confirmation message outputting step of outputting a live status confirmation message to a plurality of information processing apparatuses on the network, a determination step of determining an information processing apparatus to which to transmit an information retrieval request based on attribute information of an information processing apparatus that has responded to the live status confirmation message output in the live status confirmation message outputting step, an information retrieval request transmission step of transmitting the information retrieval request to the information processing apparatus determined in the determination step; and an information retrieval result receiving step of receiving a retrieval result from the information processing apparatus determined in the determination step.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of an information processing apparatus according to a first exemplary embodiment of the present invention.

FIG. 2 is a block diagram showing an exemplary configuration of an essential portion of the information processing apparatus and a flow of processing carried out by the information processing apparatus.

FIG. 3 is a flow chart showing a flow of processing related to transmission of attribute information, receiving of a live status confirmation message, and transmission of the attribute information upon every elapse of a predetermined period of time, between the information processing apparatus and an external information processing apparatus.

FIG. 4 is a flow chart showing a flow of processing related to receiving and management of the attribute information, transmission of the live status confirmation message, receiving and updating of the attribute information upon every elapse of a predetermined period of time, and execution of information retrieval.

FIG. 5 shows an example of a case where a type of retrieval in each of a plurality of information processing apparatuses connected to a network is used as attribute information.

FIG. 6 shows an example of a case where a type of retrieval in each of the information processing apparatuses after a predetermined period of time elapses is used as attribute information.

FIG. 7 shows an example of an attribute information management table for managing attribute information of each information processing apparatus.

FIG. 8 shows an example of an attribute information management table for managing attribute information of each information processing apparatus after a predetermined period of time elapses.

FIG. 9 shows an example of a live status confirmation message.

FIG. 10 shows an example of an input of retrieval conditions for retrieving information.

FIG. 11 shows an example of a case where a content type that can be retrieved by each of a plurality of information processing apparatuses that is connected to a network is used as attribute information according to a second exemplary embodiment of the present invention.

FIG. 12 shows an example of a case where a content type in each information processing apparatus after a predetermined period of time elapses is used as attribute information.

FIG. 13 shows an example of an attribute information management table for managing attribute information of each information processing apparatus.

FIG. 14 shows an example of an attribute information management table for managing attribute information of each information processing apparatus after a predetermined period of time elapses.

### DETAILED DESCRIPTION OF THE EMBODIMENTS

Exemplary embodiments of the invention will be described in detail below with reference to the drawings.

### First Exemplary Embodiment

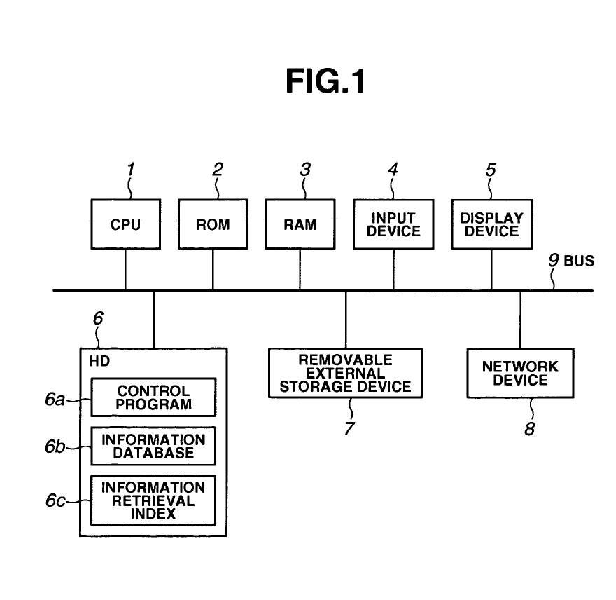

FIG. 1 is a block diagram showing a configuration of an information processing apparatus according to a first exemplary embodiment of the present invention.

In FIG. 1, the information processing apparatus includes a central processing unit (CPU) 1, a read-only memory (ROM) 2, a random access memory (RAM) 3, an input device 4, a display device 5, a hard disk (HD) 6, a removable external storage device 7, a network device 8, and a bus 9.

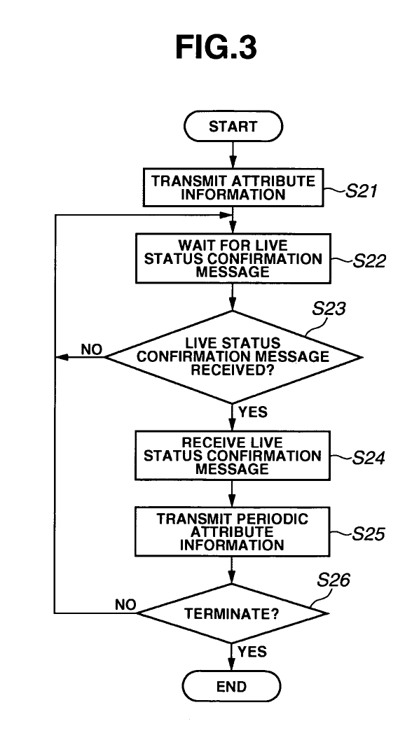

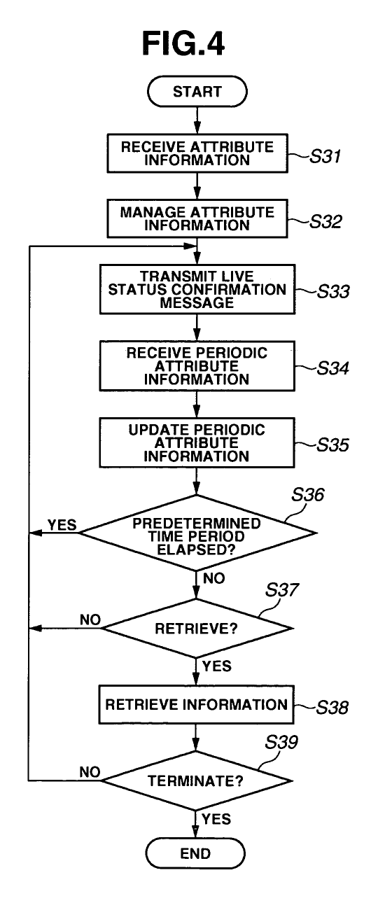

The CPU 1 is a microprocessor that controls the information processing apparatus. The CPU 1 controls each component connected to the bus 9 and carries out arithmetic operations, logical determinations and the like for information retrieval processing. The CPU 1 also serves as a unit that sends and receives data on a network. In addition, the CPU 1 carries out processing as shown in FIG. 3 and FIG. 4 on the basis of a control program stored in the hard disk 6, which is a secondary storage device. The bus 9 transfers an address signal and a control signal to be applied to each component controlled by the CPU 1 and transfers data between each of the components.

The RAM 3 is a random access memory into which data can be written, and is used for temporarily storing various kinds of data from each component. The ROM 2 is a read-only static memory and stores a boot program executed by the CPU 1. The boot program loads a control program stored in the hard disk 6 into the RAM 3 at the time of activation of the apparatus and allows the CPU 1 to execute the control program. The control program is explained below in detail with reference to the flow charts of FIGS. 3 and 4.

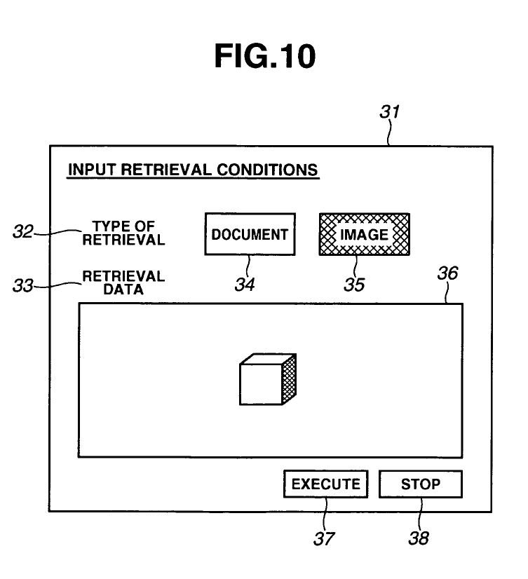

The input device 4 includes a keyboard, a mouse, and the like, and is used for inputting data and an instruction. The display device 5 is configured by a cathode ray tube (CRT) display, a liquid crystal display (LCD), and the like, and displays a screen, such as that shown in FIG. 10. The hard disk 6 as a memory stores a control program 6a executed by the CPU 1, an information database 6b that stores electronic information that is electronically produced, and an information retrieval index 6c that is used as an index in retrieving information.

The removable external storage device 7 includes a drive used to access an external storage device, such as a floppy disk, a compact disk (CD), and a digital versatile disk (DVD). The removable external storage device 7 can be used in the same manner as the hard disk 6, and interchanges data with another information processing apparatus through the external storage device. Note that the control program 6a to be stored in the hard disk 6 can be copied into the hard disk 6 from the external storage device if needed. The network device 8 is a network controller that interchanges data with a plurality of information processing apparatuses via a network.

The information processing apparatus according to this embodiment is operated in accordance with various kinds of inputs from the input device 4. When the information processing apparatus receives a predetermined input from the input device 4, an interruption signal is transmitted to the CPU 1. In accordance with this signal, the CPU 1 reads various kinds of commands stored in the ROM 2 or the RAM 3. Then, the various kinds of commands are executed, and various kinds of control are carried out.

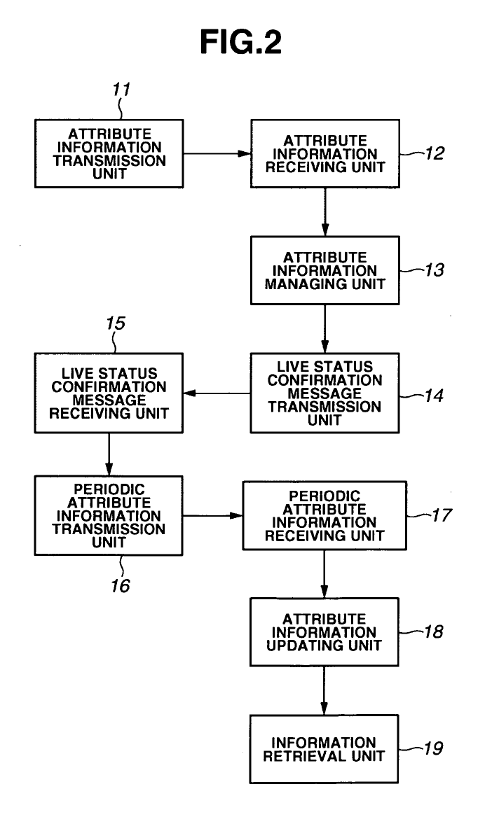

FIG. 2 is a block diagram showing a software configuration of an essential portion of the information processing apparatus as well as a flow of processing.

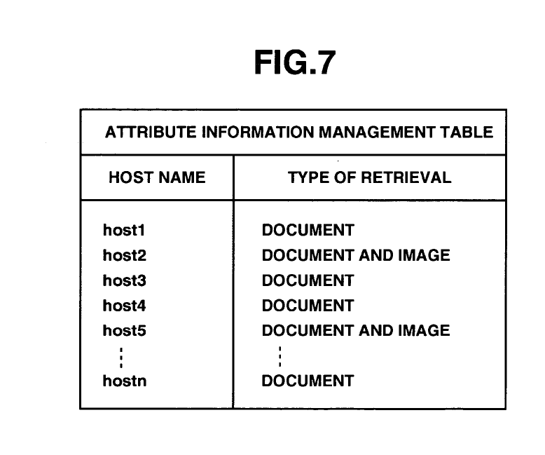

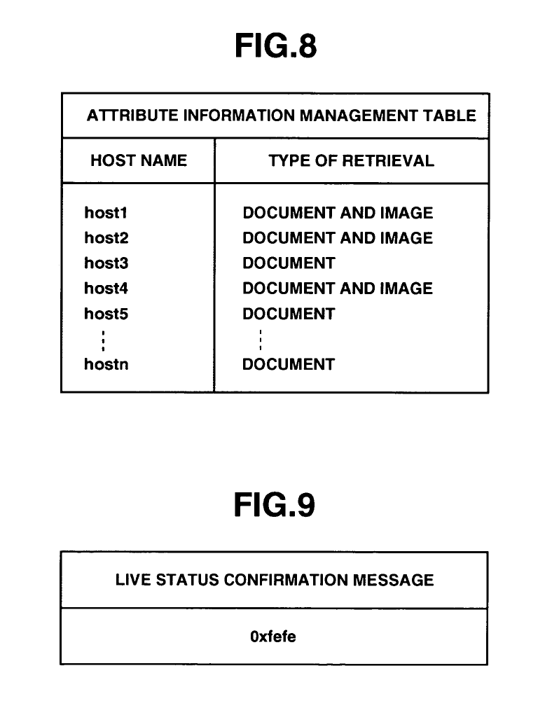

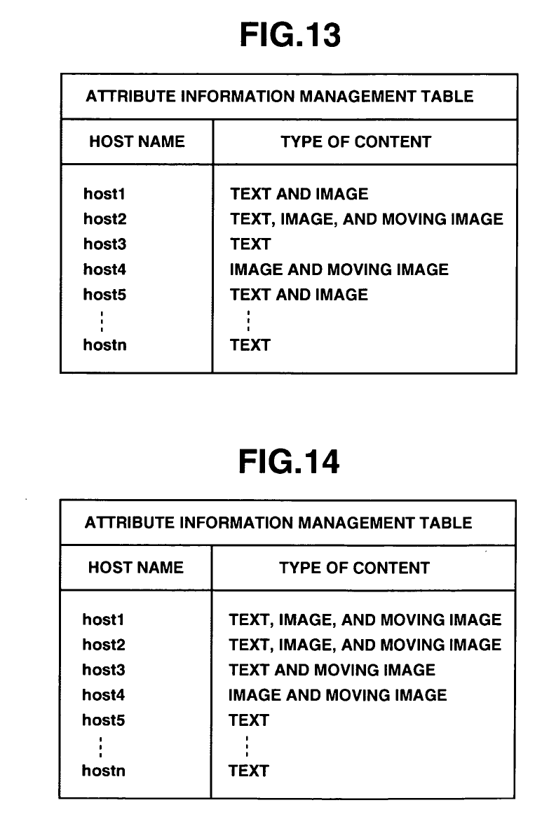

In FIG. 2, the information processing apparatus functionally includes an attribute information transmission unit 11, an attribute information receiving unit 12, an attribute information managing unit 13, a live status confirmation message transmission unit 14, a live status confirmation message receiving unit 15, a periodic attribute information transmission unit 16, a periodic attribute information receiving unit 17, an attribute information updating unit 18, and an information retrieval unit 19. Note that each of the units 11 through 19 is shown in a block diagram, representing the various functions of the CPU 1. The attribute information transmission unit 11 transmits attribute information of an information processing apparatus. The attribute information receiving unit 12 receives attribute information of an information processing apparatus that is transmitted by the attribute information transmission unit 11. The attribute information managing unit 13 manages attribute information of an information processing apparatus that is received by the attribute information receiving unit 12. The attribute information managing unit 13 stores an attribute information management table such as the one shown in FIGS. 7 and 8 (first exemplary embodiment) or an attribute information management table such as the one shown in FIGS. 13 and 14 (second exemplary embodiment). The stored attribute information management table can be updated as necessary. The live status confirmation message transmission unit 14 transmits a message for confirming a live status (a status in which an information processing apparatus is connected to a network and a communication can be established through the network) of an information processing apparatus upon every elapse of a predetermined period of time. The live status confirmation message receiving unit 15 receives a live status message of an information processing apparatus transmitted by the live status confirmation message transmission unit 14 upon every elapse of the predetermined period of time.

The periodic attribute information transmission unit 16 transmits, upon every elapse of a predetermined period of time, attribute information of an information processing apparatus in response to the live status confirmation message of an information processing apparatus received by the live status confirmation message receiving unit 15 upon every elapse of the predetermined period of time. The periodic attribute information receiving unit 17, upon every elapse of the predetermined period of time, receives attribute information of an information processing apparatus transmitted by the periodic attribute information transmission unit 16 upon every elapse of the predetermined period of time. The attribute information updating unit 18 updates attribute information of an information processing apparatus received by the periodic attribute information receiving unit 17, from the attribute information of the information processing apparatus managed by the attribute information managing unit 13. The information retrieval unit 19 executes information retrieval processing corresponding to the attribute information of an information processing apparatus.

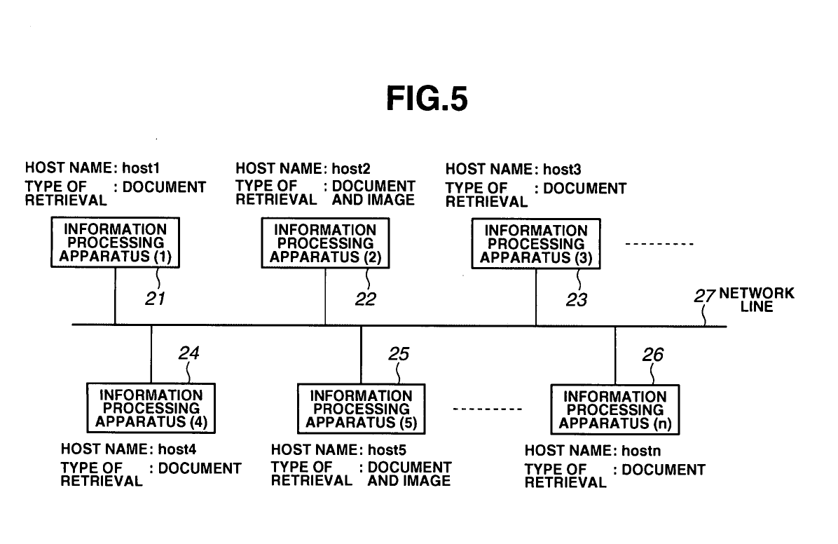

FIG. 5 is a view showing one example of a case where a type of retrieval in each of a plurality of information processing apparatuses connected to a network is used as attribute information.

In FIG. 5, information processing apparatuses listed are connected to a network line 27:

Information processing apparatus (1) 21 (host name: “host1”);

Information processing apparatus (2) 22 (host name: “host2”);

Information processing apparatus (3) 23 (host name: “host3”);

Information processing apparatus (4) 24 (host name: “host4”);

Information processing apparatus (5) 25 (host name: “host5”); . . . and

Information processing apparatus (n) 26 (host name: “hostn”).

Types of information (data) in each of the information processing apparatuses that can be retrieved during information retrieval are as described below. In addition, FIG. 7 shows an example of an attribute information management table, which the attribute information managing unit 13 uses to manage attribute information of the type of retrieval of each information processing apparatus. The attribute information management table shown in FIG. 7 is stored in the hard disk 6. Note that the “type of retrieval” in this embodiment represents the type of a retrieving method. For example, the type of retrieval “document” represents that document data including text data inputted as a retrieval query can be retrieved. The type of retrieval “image” represents that image data similar to image data inputted as a retrieval query can be retrieved.

The Types of Retrieval in Each Information Processing Apparatus before the Elapse of a Predetermined Time in the example shown in FIGS. 5 and 7 are as follows:

Information processing apparatus 21 (1) (host name: “host1”): Type of Retrieval “Document”;

Information processing apparatus 22 (2) (host name: “host2”): Type of Retrieval “Document and Image”;

Information processing apparatus 23 (3) (host name: “host3”): Type of Retrieval “Document”;

Information processing apparatus 24 (4) (host name: “host4”): Type of Retrieval “Document”;

Information processing apparatus 25 (5) (host name: “host5”): Type of Retrieval “Document and Image”; . . . and

Information processing apparatus 26 (n) (host name: “hostn”): Type of Retrieval “Document”.

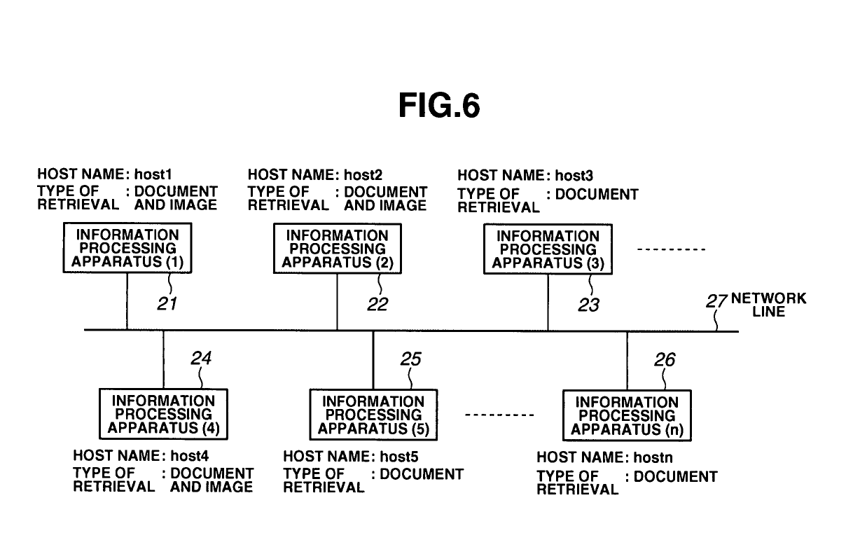

FIG. 6 shows an example of a case where the type of retrieval in each of the information processing apparatuses after the predetermined period of time elapses is used as attribute information. FIG. 8 shows example of an attribute information management table used for managing attribute information of each information processing apparatus after the predetermined period of time elapses. The attribute information management table shown in FIG. 8 is stored in the hard disk 6.

The Types of Retrieval Information in Each Information Processing Apparatus after the Elapse of the Predetermined Time in the example shown in FIGS. 6 and 8 are as follows:

Information processing apparatus (1) 21 (host name: “host1”): Type of Retrieval “Document and Image”;

Information processing apparatus (2) 22 (host name: “host2”): Type of Retrieval “Document and Image”;

Information processing apparatus (3) 23 (host name: “host3”): Type of Retrieval “Document”;

Information processing apparatus (4) 24 (host name: “host4”): Type of Retrieval “Document and Image”;

Information processing apparatus (5) 25 (host name: “host5”): Type of Retrieval “Document”; . . . and

Information processing apparatus (n) 26 (host name: “hostn”): Type of Retrieval “Document”.

FIG. 9 shows an example of a live status confirmation message. In FIG. 9, the live status confirmation message, which is a message for confirming the live status of each information processing apparatus upon every elapse of the predetermined period of time is, for example, expressed by a two-byte code “0xfefe”.

FIG. 10 shows an example of an input interface of retrieval conditions for retrieving information.

In FIG. 10, a retrieval condition input screen 31 is displayed on the display device 5 of the information processing apparatus. The retrieval conditions include a type of retrieval 32 and retrieval data 33. The type of retrieval 32 can be used to select whether data that is subjected to information retrieval is “Document” data 34 or “Image” data 35. In addition, the retrieval data 33 can be used to input a word, a sentence, or an image into an input region 36. FIG. 10 shows a state where “Image” 35 is selected for the type of retrieval 32. In addition, an image shown in FIG. 10 is input as the retrieval data (query) 33. In this state, when an “Execute” key 37 is selected, information retrieval is executed, and when a “Stop” key 38 is selected, the input of the retrieval conditions is canceled.

Next, an explanation is made in detail as to an operation of information retrieval processing according to this embodiment.

FIG. 3 is a flow chart showing processing related to transmission of the attribute information of a type of retrieval and receiving of the live status confirmation message between the information processing apparatus (e.g., host1) and an external information processing apparatus.

In step S21 in FIG. 3, the attribute information transmission unit 11 of the information processing apparatus (host1) transmits, in an initialization processing, the attribute information of a type of retrieval of the information processing apparatus to external information processing apparatuses (host2 through hostn). For example, as shown in FIG. 5, the information processing apparatus (host name: “host1”) transmits the type of retrieval “Document” as attribute information.

In step S22, the live status confirmation message receiving unit 15 waits for receiving the live status confirmation message of an information processing apparatus transmitted by the live status confirmation message transmission unit 14 of an external information processing apparatus upon every elapse of a predetermined period of time. In step S23, the live status confirmation message receiving unit 15 determines whether the live status confirmation message is received. If the live status confirmation message is not received, processing returns to step S22. If the live status confirmation message is received, processing proceeds to step S24.

In step S24, the live status confirmation message receiving unit 15 receives the live status confirmation message of an information processing apparatus that is transmitted by the live status confirmation message transmission unit 14 in step S22 upon every elapse of the predetermined period time. For example, as shown in FIG. 9, the live status confirmation message receiving unit 15 receives the live status confirmation message “Live Status Confirmation Message (0xfefe)” of an external information processing apparatus.

In step S25, the periodic attribute information transmission unit 16 transmits, upon every elapse of the predetermined period of time, the attribute information of the information processing apparatus with respect to the live status confirmation message of the information processing apparatus received in step S24 upon every elapse of the predetermined time. For example, as shown in FIG. 6, the information processing apparatus (1) (host name: “host1”) transmits the type of retrieval (for example, “Document and Image”) as attribute information, upon every elapse of the predetermined time.

In step S26, the periodic attribute information transmission unit 16 determines whether processing is terminated. If processing is continued (i.e., not terminated) processing returns to step S22.

FIG. 4 is a flow chart showing a flow of processing by the information processing apparatus (host1) related to the receiving of attribute information of the type of retrieval from an external information processing apparatus, the transmission of a live status confirmation message to an external information processing apparatus, and the execution of information retrieval.

In step S31 in FIG. 4, the attribute information receiving unit 12 of the information processing apparatus (host1) receives attribute information of the type of retrieval of an information processing apparatus that is transmitted by the attribute information transmission unit 11 of the external information processing apparatus (host2 through hostn). For example, the information processing apparatus (1) (host name: “host1”) receives from the information processing apparatus (2) (host name: “host2”) the type of retrieval “Document and Image” as attribute information.

In step S32, the attribute information managing unit 13 of the information processing apparatus (host1) manages the attribute information of an information processing apparatus received by the attribute information receiving unit 12 in step S31. For example, the attribute information managing unit 13 of the information processing apparatus (host1) manages the attribute information of the types of retrieval of the information processing apparatus (1) (host name: “host1”) through the information processing apparatus (n) (host name: “hostn”) by using the attribute information management table shown in FIG. 7.

In step S33, the live status confirmation message transmission unit 14 of the information processing apparatus (host1) transmits a message for confirming the live status of the external information processing apparatuses (host2 through hostn) upon every elapse of a predetermined time. For example, the live status confirmation message transmission unit 14 transmits the message for confirming the live status “Live Status Confirmation Message (0xfefe)” of an external information processing apparatus, as shown in FIG. 9.

In step S34, the periodic attribute information receiving unit 17 of the information processing apparatus (host1) receives attribute information of the type of retrieval of an information processing apparatus that is transmitted by the periodic attribute information transmission unit 16. For example, as shown in FIG. 6, the information processing apparatus (1) (host name: “host1”) receives from the information processing apparatus (4) (host name: “host4”), after elapse of the predetermined time, the type of retrieval “Document and Image” as attribute information.

In step S35, the attribute information updating unit 18 of the information processing apparatus (host1) updates the attribute information of the type of retrieval of an information processing apparatus managed using the attribute information management table shown in FIG. 8 to the attribute information of an information processing apparatus that is received by the periodic attribute information receiving unit 17 in step S34. For example, the attribute information updating unit 18 updates the types of retrieval of the information processing apparatus (1) (host name: “host1”) through the information processing apparatus (n) (host name: “hostn”), to the received attribute information of the type of retrieval.

In step S36, the attribute information updating unit 18 of the information processing apparatus (host1) determines whether the predetermined period of time has elapsed. If the predetermined period of time has elapsed, processing returns to step S33. If the predetermined period of time has not elapsed, processing proceeds to step S37. For example, in this embodiment, the predetermined period of time is one hour.

In step S37, the information retrieval unit 19 detects an instruction from a user to determine whether to carry out information retrieval. If information retrieval is not to be carried out, processing returns to step S33. If information retrieval is to be carried out, processing proceeds to step S38.

In step S38, the information retrieval unit 19 executes information retrieval corresponding to the attribute information of the type of retrieval of an information processing apparatus. For example, as shown in FIG. 10, the information retrieval unit 19 detects the selection of the type of retrieval 32 and the input of the retrieval data 33 as the retrieval conditions on the retrieval condition input screen 31. Then, the information retrieval unit 19 executes information retrieval in accordance with the input of the retrieval conditions.

Here, “Image” is selected as the type of retrieval 32. In addition, in carrying out information retrieval by inputting an image shown in FIG. 10 as the retrieval data 33, the information processing apparatus (host1) transmits an information retrieval request to the information processing apparatus (2) (host name: “host2”) and the information processing apparatus (5) (host name: “host5”) corresponding to the attribute information, based on the attribute information management table shown in FIG. 7. Further, after the predetermined time has elapsed, the information processing apparatus (host1) transmits an information retrieval request to the information processing apparatus (1) (host name: “host1”), the information processing apparatus (2) (host name: “host2”), and the information processing apparatus (4) (host name: “host4”) corresponding to the attribute information, based on the attribute information management table shown in FIG. 8. Then, the information processing apparatus (host1) obtains retrieval results from those information processing apparatuses.

In step S39, the information retrieval unit 19 determines whether processing is terminated. If processing is continued (i.e., not terminated), processing returns to step S33.

As described above, according to this embodiment, the information processing apparatus (host1) that outputs a retrieval request can issue a request for information retrieval only to information processing apparatuses that correspond to the attribute information (type of retrieval) of the retrieval target. Accordingly, the traffic of a network can be reduced in transmitting a retrieval result to the information processing apparatus (host1). Especially in the case of a request for information retrieval with respect to large-capacity information such as image information, it is not necessary to transfer image data as a retrieval query to each information processing apparatus on the network. Thus, an effectiveness of reducing the network traffic can be improved. In addition, transmitting unnecessary retrieval request can be reduced.

In addition, each of the information processing apparatuses connected to the network updates the attribute information management table based on the attribute information of an information processing apparatus upon every elapse of the predetermined period of time. Therefore, a request for information retrieval to information processing apparatuses can be readily changed.

### Second Exemplary Embodiment

The second exemplary embodiment of the present invention differs from the first exemplary embodiment in points as described below. Other constituent elements of the second exemplary embodiment are similar to the corresponding constituent elements of the first exemplary embodiment (FIGS. 1 and 2), and therefore, the explanation thereof is not repeated.

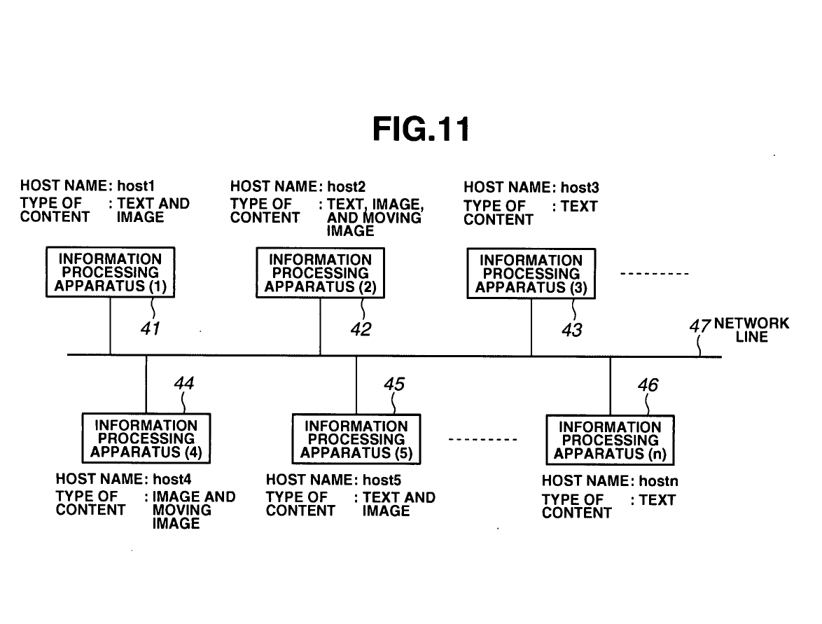

FIG. 11 shows an example of a case where the content (data) type that can be retrieved by a plurality of information processing apparatuses connected to a network is used as attribute information according to the second exemplary embodiment.

In the example shown in FIG. 11, information processing apparatuses as mentioned below are connected to the network via network line 47.

Information processing apparatus (1) 41 (host name: “host1”);

Information processing apparatus (2) 42 (host name: “host2”);

Information processing apparatus (3) 43 (host name: “host3”);

Information processing apparatus (4) 44 (host name: “host4”);

Information processing apparatus (5) 45 (host name: “host5”); . . . and

Information processing apparatus (n) 46 (host name: “hostn”).

The types of retrieval of content that can be retrieved by each information processing apparatus at a certain timing are as described below. FIG. 13 shows an attribute information management table for managing the attribute information of each information processing apparatus capable of carrying out information retrieval at this timing. Note that “Image” represents the content of a still image.

Information processing apparatus (1) 41 (host name: “host1”): Type of Content “Text and Image”;

Information processing apparatus (2) 42 (host name: “host2”): Type of Content “Text, Image, and Moving Image”;

Information processing apparatus (3) 43 (host name: “host3”): Type of Content “Text”;

Information processing apparatus (4) 44 (host name: “host4”): Type of Content “Image and Moving Image”;

Information processing apparatus (5) 45 (host name: “host5”): Type of Content “Text and Image”; . . . and

Information processing apparatus (n) 46 (host name: “hostn”): Type of Content “Text”.

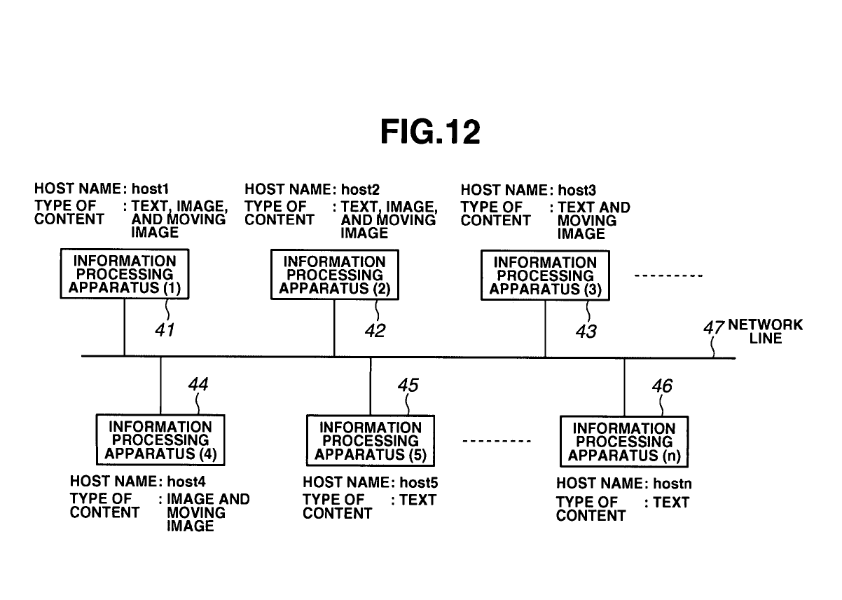

FIG. 12 shows an example of a case where a content type of each information processing apparatus after a predetermined period of time elapses from the time of the state shown in FIG. 11 is used as attribute information.

The types of content of each information processing apparatus that can be retrieved by the information processing apparatus after the predetermined time elapses are as described below. FIG. 14 shows an attribute information management table for managing the attribute information of the content that can be retrieved by each information processing apparatus shown in FIG. 12 after the predetermined period of time elapses. Note that “Image” represents the content of a still image.

Information processing apparatus (1) 41 (host name: “host1”): Type of Content “Text, Image, and Moving Image”;

Information processing apparatus (2) 42 (host name: “host2”): Type of Content “Text, Image, and Moving Image”;

Information processing apparatus (3) 43 (host name: “host3”): Type of Content “Text and Moving Image”;

Information processing apparatus (4) 44 (host name: “host4”): Type of Content “Image and Moving Image”;

Information processing apparatus (5) 45 (host name: “host5”): Type of Content “Text”; . . . and

Information processing apparatus (n) 46 (host name: “hostn”): Type of Content “Text”.

The information processing apparatus that actually executes retrieval processing periodically updates the type of content that can be retrieved by information processing apparatuses on the network including the information processing apparatus itself, in the same manner as in the first exemplary embodiment, and manages the type of content by using the tables shown in FIG. 13 and FIG. 14. Thus, the traffic of a network can be reduced as in the case of the first exemplary embodiment. In addition, transmitting unnecessary retrieval requests to information processing apparatuses that do not have the function of responding to an information retrieval request from a retrieving client information processing apparatus can be reduced. In addition, a retrieval request to information processing apparatuses can readily be changed.

While the exemplary embodiments described above use “Document”, “Image” and “Moving Image” as attribute types in determining recipients of the data, it will be appreciated that other attribute types may be used, for example, “audio”. It will also be appreciated that “attribute type” may also be something other than content type. For example, the attribute type may be the size of the data to be transmitted, a combination of the type of data and the size of the data, etc.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2005-037749 filed Feb. 15, 2005, which is hereby incorporated by reference herein in its entirety.

What is claimed is:

1. An information processing apparatus that is connected to a network, the information processing apparatus comprising:
a live status confirmation message output unit configured to output a live status confirmation message to a plurality of information processing apparatuses via the network;
a management unit configured to manage attribute information about an information processing apparatus that has responded to the live status confirmation message output by the live status confirmation message output unit;
a determination unit configured to, based on the attribute information about the information processing apparatus managed by the management unit, determine an information processing apparatus to which an information retrieval request is transmitted; and
a retrieval processing unit configured to transmit the information retrieval request to the information processing apparatus determined by the determination unit and to receive a retrieval result from the information processing apparatus determined by the determination unit.

2. The information processing apparatus according to claim 1, wherein the live status confirmation message output unit is configured to periodically output the live status confirmation message to the plurality of information processing apparatuses.

3. The information processing apparatus according to claim 1, wherein the management unit is configured to manage a type of a retrieval method by which the information processing apparatus can carry out retrieval, as the attribute information for the information processing apparatus.

4. The information processing apparatus according to claim 3, wherein the determination unit is configured to determine an information processing apparatus that can execute a retrieval method input according to an instruction from a user, as the information processing apparatus to which an information retrieval request is transmitted.

5. The information processing apparatus according to claim 1, wherein the management unit is configured to manage a type of content that can be retrieved by the information processing apparatus, as the attribute information for the information processing apparatus.

6. A retrieval processing method for an information processing apparatus connected to a network, the retrieval processing method comprising:
a live status confirmation message outputting step of outputting a live status confirmation message to a plurality of information processing apparatuses via the network;
a determination step of determining an information processing apparatus to which an information retrieval request is transmitted based on attribute information for an information processing apparatus that has responded to the live status confirmation message output in the live status confirmation message outputting step;
an information retrieval request transmission step of transmitting the information retrieval request to the information processing apparatus determined in the determination step; and
an information retrieval result receiving step of receiving a retrieval result from the information processing apparatus determined in the determination step.

7. The retrieval processing method according to claim 6, wherein the live status confirmation message outputting step periodically outputs the live status confirmation message to the plurality of information processing apparatuses.

8. The retrieval processing method according to claim 6, wherein the attribute information of the information processing apparatus includes a type of a retrieval method by which the information processing apparatus can carry out retrieval.

9. The retrieval processing method according to claim 8, wherein the determination step determines an information processing apparatus that can execute a retrieval method input according to an instruction from a user as the information processing apparatus to which an information retrieval request is transmitted.

10. The retrieval processing method according to claim 6, wherein the attribute information about the information processing apparatus includes a type of content that can be retrieved by the information processing apparatus.

11. A computer-readable medium including a computer program for executing a retrieval processing method for an information processing apparatus connected to a network, the retrieval processing method comprising:
a live status confirmation message outputting step of outputting a live status confirmation message to a plurality of information processing apparatuses via the network;
a determination step of determining an information processing apparatus to which an information retrieval request is transmitted based on attribute information for an information processing apparatus that has responded to the live status confirmation message output in the live status confirmation message outputting step;
an information retrieval request transmission step of transmitting the information retrieval request to the information processing apparatus determined in the determination step; and
an information retrieval result receiving step of receiving a retrieval result from the information processing apparatus determined in the determination step.

12. The computer-readable medium according to claim 11, wherein the live status confirmation message outputting step periodically outputs the live status confirmation message to the plurality of information processing apparatuses.

13. The computer-readable medium according to claim 11, wherein the attribute information about the information processing apparatus includes a type of a retrieval method by which the information processing apparatus can carry out retrieval.

14. The computer-readable medium according to claim 13, wherein the determination step determines an information processing apparatus that can execute a retrieval method input according to an instruction from a user as the information processing apparatus to which to transmit an information retrieval request.

15. The computer-readable medium according to claim 11, wherein the attribute information of the information processing apparatus includes a type of content that can be retrieved by the information processing apparatus.
